(19) United States
(12) Patent Application Publication
(10) Pub. No.: US 2011/0193785 A1
(43) Pub. Date: Aug. 11, 2011

(54) Intuitive Grouping and Viewing of Grouped Objects Using Touch

(76) Inventors: Deborah C. Russell, Austin, TX (US); David Brebner, Palmerston North (NZ); Robert Grapes, Palmerston North (NZ)

(21) Appl. No.: 12/701,827

(22) Filed: Feb. 8, 2010

(51) Int. Cl. G06F 3/041

(52) U.S. Cl. 345/173

(57) ABSTRACT

A system for providing intuitive grouping and viewing of grouped objects using touch. The system enables a touch screen interaction with simple gestural inputs. The system allows simple grouping and ungrouping of objects in a touch screen environment. Specifically, a user can tap on an object and drag it on top of another object. The first object is associated with (e.g., sticks to) the second object, thereby forming a pile. The pile can continue to be used to “stick” to other single objects and/or formed piles. The pile can then be used to organize and/or send objects to another desired location. When a user selects objects and creates piles, the interface may elicit feedback to provide an affordance to the user's behavior. In various embodiments, the feedback may include visual, tactile and/or auditory feedback.

### BACKGROUND OF THE INVENTION

1. Field of the Invention

The present invention relates to information handling systems and more particularly to intuitive grouping and viewing of grouped objects using touch.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

It is known to provide information handling systems with touch sensitive display devices. There are a number of issues relating to developing user interfaces for touch sensitive display devices. One issue is that many user interface developers are accustomed to developing user interfaces for mouse/keyboard type input. Accordingly touch applications are often designed by modifying traditional interfaces to be bigger and offer few other direct object manipulation scenarios (such as rotate and zoom). The resulting user interface thus often looks and behaves like keyboard/mouse type interfaces (e.g., the user interface includes select buttons to perform actions and manipulate an object with limited functionality.)

### SUMMARY OF THE INVENTION

In accordance with the present invention, a system for providing intuitive grouping and viewing of grouped objects using touch is set forth. The system enables a touch screen interaction with simple gestural inputs. The system allows simple grouping and ungrouping of objects in a touch screen environment. Specifically, a user can tap on an object and drag it on top of another object. The first object is associated with (e.g., sticks to) the second object, thereby forming a pile. The pile can continue to be used to “stick” to other single objects and/or formed piles. The pile can then be used to organize and/or send objects to another desired location. When a user selects objects and creates piles, the interface may elicit feedback to provide an affordance to the user's behavior. In various embodiments, the feedback may include visual, tactile and/or auditory feedback. Such a system enables direct object manipulation and experiences with touch screen devices that are fun and inviting.

More specifically, in one embodiment, the invention relates to a method for providing intuitive grouping and viewing of grouped objects using touch. The method includes providing a touch sensitive display device; presenting a first object on the touch sensitive display device; sensing when the first object is touched; enabling the first object to be dragged based upon a user dwelling on the first object; and, associating the first object with a second object when the first object is dragged in proximity to the second object, the associating creating a pile containing the first object and the second object.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a system block diagram of an information handling system.

FIG. 2 shows a flow chart of the operation of a system for providing intuitive grouping and viewing of grouped objects using touch.

FIG. 3 shows another flow chart of the operation of a system for providing intuitive grouping and viewing of grouped objects using touch.

### DETAILED DESCRIPTION

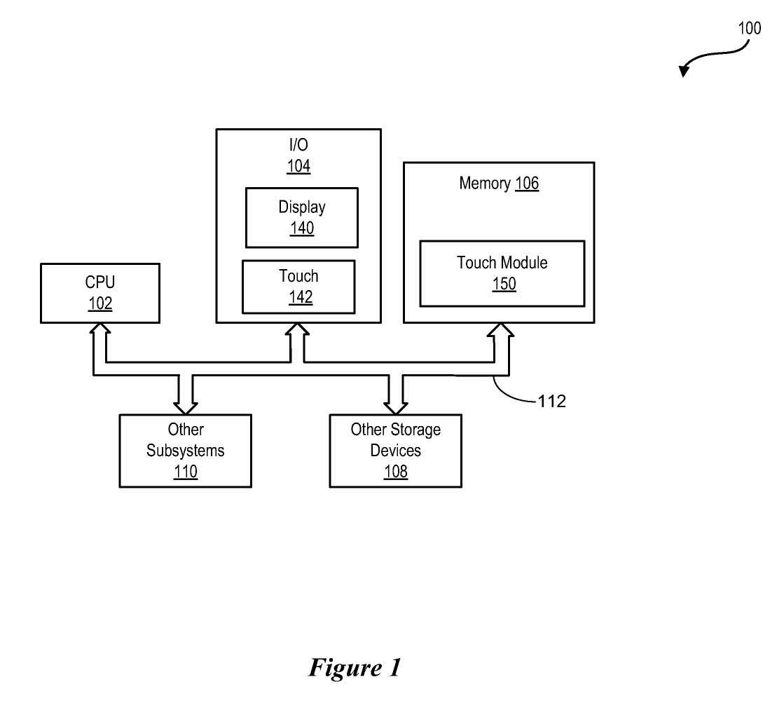

Referring briefly to FIG. 1, a system block diagram of an information handling system 100 is shown. The information handling system 100 includes a processor 102, input/output (I/O) devices 104, such as a display, a keyboard, a mouse, and associated controllers (each of which may be coupled remotely to the information handling system 100), a memory 106 including volatile memory such as random access memory (RAM) and non-volatile memory such as a hard disk and drive, and other storage devices 108, such as an optical disk and drive and other memory devices, and various other subsystems 110, all interconnected via one or more buses 112.

The I/O devices 104 can include a display 140 as well as a touch input device 142. The touch input device 142 may be integrated into the display such that the display is a touch sensitive display device.

The information handling system further includes a touch system 150 for providing intuitive grouping and viewing of grouped objects using touch stored on the memory 106 and executable by the processor 102. The system enables a touch screen interaction with simple gestural inputs. The system allows simple grouping and ungrouping of objects in a touch screen environment. Specifically, a user can tap on an object and drag it on top of another object. The first object is associated with (e.g., sticks to) the second object, thereby forming a pile. The pile can continue to be used to “stick” to other single objects and/or formed piles. The pile can then be used to organize and/or send objects to another desired location. When a user selects objects and creates piles, the interface may elicit feedback to provide an affordance to the user's behavior. In various embodiments, the feedback may include visual, tactile and/or auditory feedback. Such a system enables direct object manipulation and experiences with touch screen devices that are fun and inviting.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

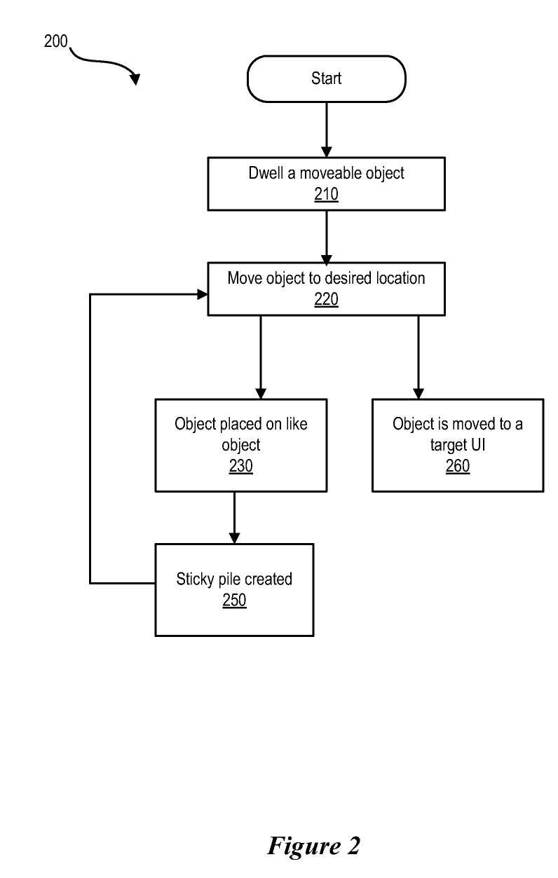

Referring to FIG. 2, a flow chart of the operation of a system 200 for providing intuitive grouping and viewing of grouped objects using touch is shown. The system provides for more than viewing of objects, but also transporting itself or other objects. More specifically, in certain embodiments, the system allows a user to tap an object and then drag the object across the interface. The selected object can then act as a magnet which allows subsequent objects to stick to the first object and to form a pile.

More specifically, a user dwells on a movable object (e.g., by tapping and holding the object) at step 210 and then moves the object to a desired location at step 220. The movement may be accomplished by dragging the object via touch. If the object is placed on a like object as determined by step 230, then a sticky pile is created at step 250. Alternately, when the object is moved at step 220, the desired location to which the object is moved may be a target user interface element (e.g., a queue, a bin, or other type of user interface element) at step 260.

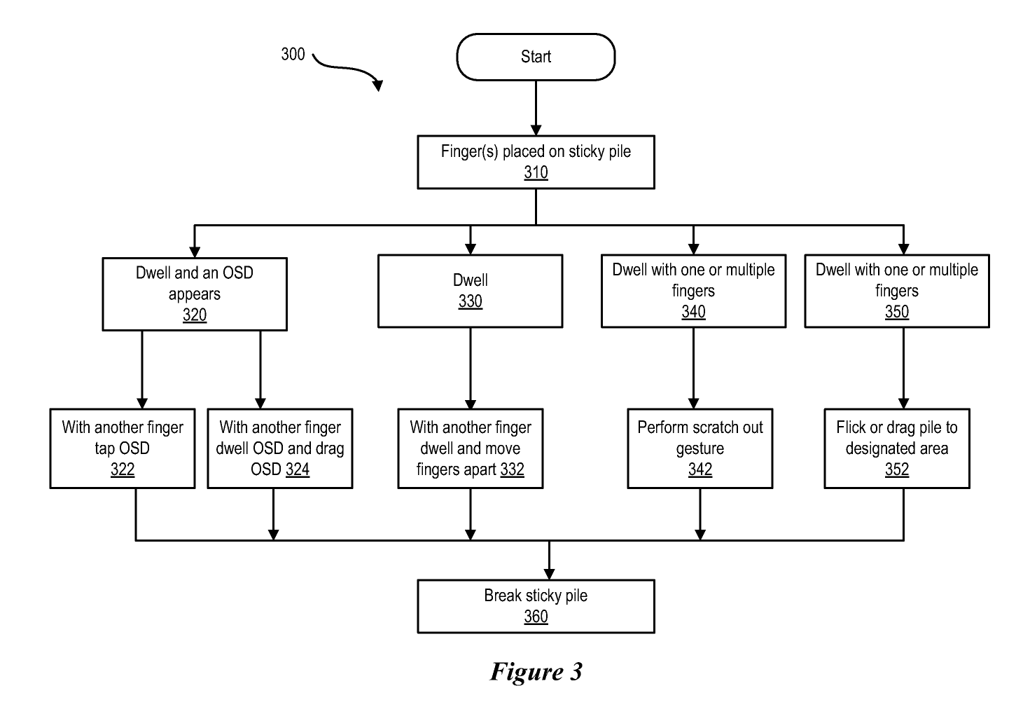

Referring to FIG. 3, a flow chart of the operation of a system 300 for providing intuitive ungrouping of grouped objects using touch is shown. Ungrouping (i.e., breaking the sticky pile) may be accomplished via any of a plurality of operations.

More specifically, ungrouping of the associated pile of objects starts by placing a finger (or fingers) on the pile at step 310. Next at step 320, the user dwells on the object and an on screen display (OSD) appears. The OSD includes a visual affordance or graphic which relects an unstuck behavior. When the OSD appears, the user can then tap the OSD with another finger at step 322 or dwell on the OSD and drag the OSD at step 324. Alternately, at step 330 a user can dwell on the pile and then use another finger to dwell on the pile and move the figures apart at step 332 (effectively spreading the pile across the workspace). Alternately, at step 340 a user can dwell on the pile and then perform a scratch out gesture the break the pile loose. Alternately, at step 350 a user can dwell on the pile and then perform a flick or drag motion at step 352 to move the pile to a designated area. Each of these operations would effectively ungroup (i.e., break) the sticky pile at step 360.

Thus, the touch system 150 for providing intuitive grouping and viewing of grouped objects provides a touch friendly dynamic interface which includes a tangible user interface and offers a realistic two dimensional experience. The system provides users with the ability to connect a plurality of objects on a screen such that the object behave as dynamic (rather than passive) objects. The interaction offers an exciting way to use a touch screen by implementing gestures and utility in various software applications.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Also for example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably, or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A method for providing intuitive grouping and viewing of grouped objects using touch comprising:
providing a touch sensitive display device;
presenting a first object on the touch sensitive display device;
sensing when the first object is touched;
enabling the first object to be dragged based upon a user dwelling on the first object; and, associating the first object with a second object when the first object is dragged in proximity to the second object, the associating creating a pile containing the first object and the second object.

2. The method of claim 1 further comprising:
enabling the pile to be dragged based upon a user dwelling on the pile; and,
associating the first object and the second object with a third object when the pile is dragged in proximity to the third object.

3. The method of claim 1 further comprising:
using the pile to move the first and second objects to a desired location, the desired location being represented on the touch sensitive display device.

4. The method of claim 1 further comprising:
generating feedback to provide an affordance to behavior of the user.

5. The method of claim 4 wherein:
the feedback comprises at least one of visual, tactile and auditory feedback.

6. The method of claim 1 further comprising:
unassociating the first object and the second object in response to gestural input of the user.

7. An information handling system comprising
a processor;
a memory coupled to the processor, the memory storing a system for providing intuitive grouping and viewing of grouped objects using touch, the system comprising instructions executable by the processor for:
providing a touch sensitive display device;
presenting a first object on the touch sensitive display device;
sensing when the first object is touched;
enabling the first object to be dragged based upon a user dwelling on the first object; and,
associating the first object with a second object when the first object is dragged in proximity to the second object, the associating creating a pile containing the first object and the second object.

8. The information handling system of claim 7 wherein the system further comprises instructions for:
enabling the pile to be dragged based upon a user dwelling on the pile; and,
associating the first object and the second object with a third object when the pile is dragged in proximity to the third object.

9. The information handling system of claim 7 wherein the system further comprises instructions for:
using the pile to move the first and second objects to a desired location, the desired location being represented on the touch sensitive display device.

10. The information handling system of claim 7 wherein the system further comprises instructions for:
generating feedback to provide an affordance to behavior of the user.

11. The information handling system of claim 10 wherein:
the feedback comprises at least one of visual, tactile and auditory feedback.

12. The information handling system of claim 7 wherein the system further comprises instructions for:
unassociating the first object and the second object in response to gestural input of the user.
